(19) United States
(12) Patent Application Publication
(10) Pub. No.: US 2007/0030350 A1
(43) Pub. Date: Feb. 8, 2007

(54) Remote inspection apparatus for vehicles

(76) Inventor: Ervin Wagner, St. Joseph, MI (US)

Correspondence Address: Taglia, Fette, Dumke & White, P.C., 720 State Street, P.O. Box 890, St. Joseph, MI, 49085, US

(21) Appl. No.: 11/196,879

(22) Filed: Aug. 4, 2005

(51) Int. Cl. H04N 7/18

(52) U.S. Cl. 348/148

(57) ABSTRACT

A remote inspection apparatus for inspecting a stopped vehicle from a second vehicle including a boom extendable in a generally horizontal direction mounted to the second vehicle having an articulated distal surveillance end. The surveillance end can include a plurality of surveillance devices selected from a group including an imaging device and one or more lights, audio communication equipment including a microphone and speaker, a fingerprint scanner, an explosives detector, a controlled substance detector and a canister. A controller including a display device can be provided for the extendable boom arranged to permit an operator positioned in the second vehicle operate the extendable boom, the articulated distal surveillance end portion and the plurality of surveillance devices to allow the operator to maneuver and control operation of the surveillance devices.

### BACKGROUND OF THE INVENTION

1. Field of the Invention

The invention relates to apparatus mounted on a vehicle for conducting remote inspections or surveillance of another vehicle. The remote inspection apparatus can be used by law enforcement personnel to inpect the interior of a stopped vehicle from their vehicle before approaching the stopped vehicle.

2. Prior Art

The prior art includes a variety of telescoping mounts for video cameras and other surveillance equipment. The prior art also includes hand held remote inspection and observation equipment.

### SUMMARY OF THE INVENTION

The invention relates to a remote inspection or surveillance apparatus for inspecting a stopped vehicle from a second vehicle including a longitudinally extendable boom mounted to the second vehicle having an imaging device positioned at the distal end of the boom. A display device in the second vehicle can be connected to the imaging device and to a controller for the extendable boom. The controller can permit an operator positioned in the second vehicle to aim the imaging device into the stopped vehicle to allow the operator to inspect the interior of the stopped vehicle on the display device.

The extendable boom can be extendable in a generally horizontal direction.

The extendable boom can include an articulated distal end portion arranged to allow the operator to maneuver and control the field of view of the imaging device.

In another aspect of the invention the extendable boom can be pivotally mounted to the second vehicle about a generally vertical axis to allow the operator to position the imaging device on either side of the stopped vehicle to allow inspection of the stopped vehicle from either side.

In another aspect of the invention the extendable boom can be slidably mounted to the second vehicle in a generally horizontal plane to allow the operator to position the imaging device on either side of the stopped vehicle to allow inspection of the stopped vehicle from either side.

The remote inspection apparatus can include audio communication apparatus positioned at the distal end and in the second vehicle arranged to permit the operator to communicate with an occupant in the stopped vehicle.

The remote inspection apparatus can include a document chamber arranged for receiving a document from an occupant in the stopped vehicle, wherein the operator can collect a document from the stopped vehicle without leaving the second vehicle.

The remote inspection apparatus can include a fingerprint collection surface on the distal end of the boom.

The remote inspection apparatus can include a detector for detecting controlled substances and explosive materials.

In another aspect the invention relates to a remote inspection apparatus for inspecting a stopped vehicle from a second vehicle including a boom extendable in a generally horizontal direction mounted to the second vehicle having an articulated distal surveillance end having a plurality of surveillance devices positioned in the surveillance end selected from a group including one or more of an imaging device and one or more lights, audio communication equipment including a microphone and speaker, a fingerprint scanner, an explosives detector, a controlled substance detector and a canister. The remote inspection apparatus can include a controller for the extendable boom arranged to permit an operator positioned in the second vehicle operate the extendable boom, the articulated distal surveillance end portion and the plurality of surveillance devices to allow the operator to maneuver and control operation of the surveillance devices. The controller can include a display device in the second vehicle connected to the controller to allow the operator to inspect the interior of the stopped vehicle on the display device and communicate with the occupant(s) of the stopped vehicle via the audio communication equipment.

### BRIEF DESCRIPTION OF THE DRAWINGS

FIG. 1 is a side view of a remote inspection apparatus according to the invention installed on a police vehicle in a retracted position adjacent another vehicle;

FIG. 2 is a side view of a remote inspection apparatus according to the invention installed on a different police vehicle in an extended position to inspect the interior of another vehicle;

FIG. 2A is a top view of another embodiment of a remote inspection apparatus according to the invention that is movably mounted on a police vehicle to inspect either side of another vehicle;

FIG. 2B is a top view of another embodiment of a remote inspection apparatus according to the invention that is movably mounted on a police vehicle to inspect either side of another vehicle;

FIG. 3 is a schematic view of a partially extended remote inspection apparatus according to the invention;

FIG. 4 is a schematic view of a retracted remote inspection apparatus according to the invention g one mounting embodiment;

FIG. 5 is a perspective view illustrating one embodiment of a display device that can be used with remote inspection equipment according to the invention.

### DESCRIPTION OF THE INVENTION

Approaching a stopped vehicle can be dangerous for law enforcement personnel, particularly at night or in the case of darkened windows on the stopped vehicle that can make viewing the occupant(s) of a vehicle difficult or impossible without approaching the vehicle and even until the occupant(s) of the stopped vehicle rolls down a window or opens a door. Once a law enforcement officer has approached a vehicle and is standing adjacent the driver's door the officer is exposed and can be at risk of injury or death before having a chance to observe the occupants of the vehicle to assess the risk. According to the invention a remote inspection apparatus can be mounted on a law enforcement vehicle to allow remote observation and inspection of, and communication with, the occupant(s) of a stopped vehicle prior to approaching the stopped vehicle. Applicant will refer to the remote inspection apparatus as a “remote inspection apparatus” in this application. However, the term “inspection” should also be understood to include “surveillance”. The apparatus according to the invention can be a “remote surveillance apparatus” as well as a “remote inspection apparatus”.

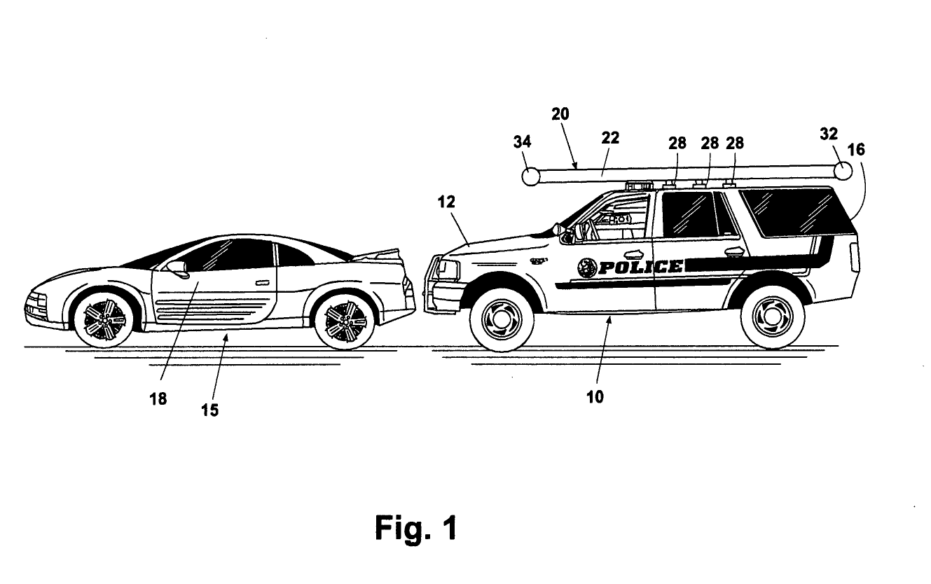

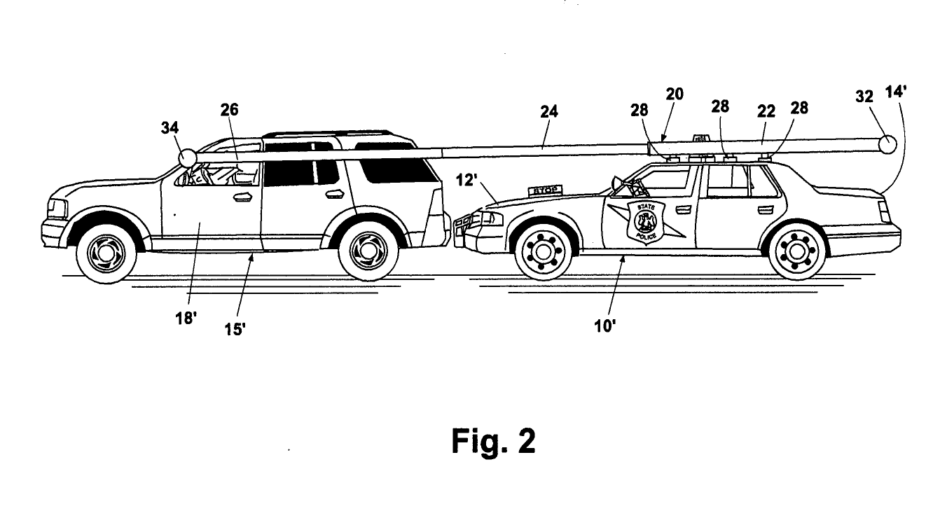

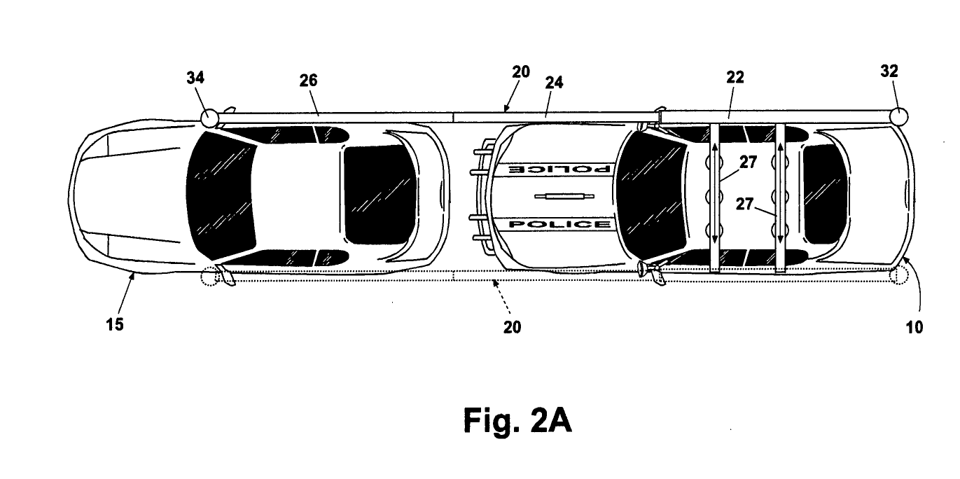

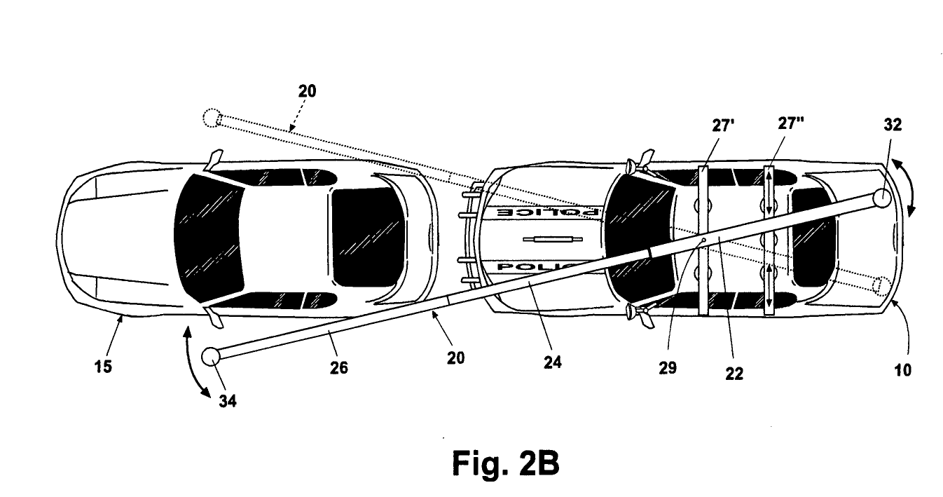

Turning to FIGS. 1 and 2, a law enforcement vehicle 10, 10′ can have a remote inspection apparatus 20 mounted to the roof of vehicle 10, 10′. The remote inspection apparatus 20 will be described in this application in combination with a law enforcement vehicle 10, 10′ however, as those skilled in the art will readily understand, the remote inspection apparatus can be used in combination with a military vehicle, homeland security vehicle or other vehicle as desired. Remote inspection apparatus 20 can be normally retracted as illustrated in FIG. 1 to allow vehicle 10′ to be operated in a normal manner without interference of an extended remote inspection apparatus 20. When a law enforcement vehicle 10, 10′ is positioned adjacent another stopped vehicle 15, 15′ and the law enforcement personnel operating the vehicle 10, 10′ can not see into the stopped vehicle 15, 15′ the remote inspection apparatus 20 can be extended as illustrated in FIG. 2 to allow remote inspection of the interior of stopped vehicle 15, 15′ as described in detail below.

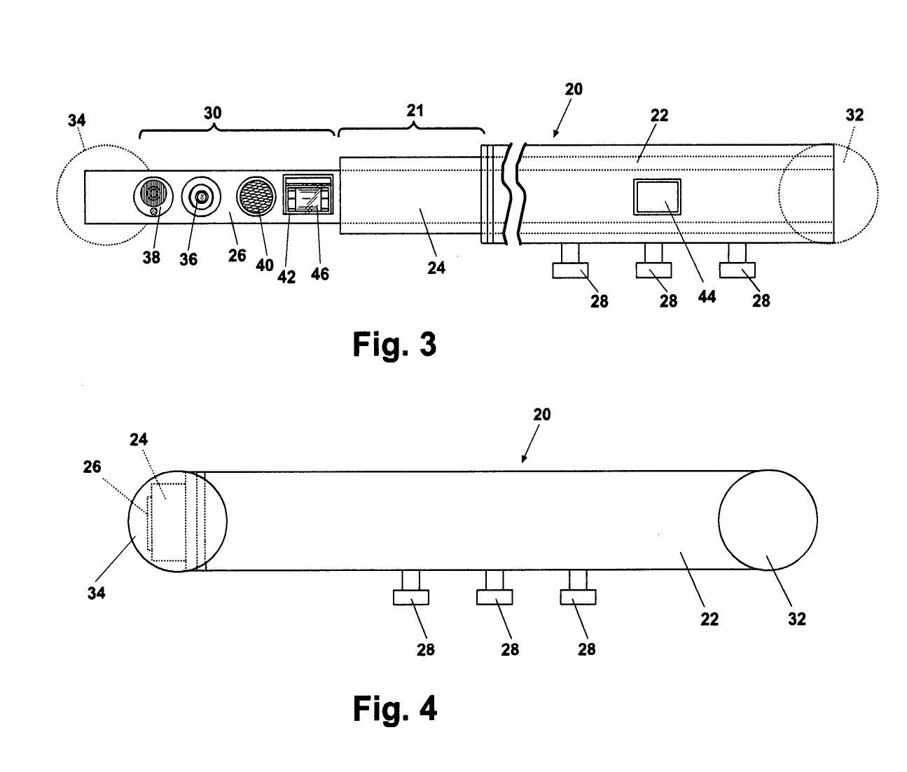

Turning to FIG. 3, remote inspection apparatus 20 can include a multiple element telescoping housing including elements 22, 24 and 26 that can form a longitudinally extendable boom 21. While the schematic illustration of the remote inspection apparatus in FIG. 3 includes three telescoping elements 22, 24 and 26 forming extendable boom 21, those skilled in the art will understand that more or less than three telescoping elements can be used to provide any desired extension of the remote inspection apparatus. The retracted length of extendable boom 21 can be selected to allow operation and service of the law enforcement vehicle without undue interference from the remote inspection apparatus 20. For example, the length and mounting position for the remote inspection apparatus 20 can be selected such that the hood 12′ and trunk 14 of a sedan such as vehicle 10′ and the hood 12 and tailgate 16 of a vehicle such as vehicle 10 can be opened and closed without interference from the remote inspection apparatus 20. Remote inspection apparatus 20 can include a drive arrangement (not shown) to drive housing elements 24 and 26 from a retracted position (FIGS. 1 and 4) to an extended position (FIGS. 2 and 3). In one embodiment the retracted length of a remote inspection apparatus can be approximately 120″ and can have approximately 240″ extension to allow surveillance end 30 to be positioned opposite the drivers' door window of a stopped vehicle 15, 15′. Those skilled in the art will understand that the retracted and extended length of remote inspection apparatus 20 can be adjusted as desired for mounting convenience and to allow desired spacing between a law enforcement vehicle 10, 10′ and a stopped vehicle 15, 15′ when the remote inspection apparatus is used. Housing elements 24 and 26 can be operated using well known telescoping element drive arrangements that can be mechanical, electrical, pneumatic or hydraulic. The telescoping drive arrangement can be selected to allow the operator to control the extension of housing elements 24 and 26 to selectively position surveillance end 30 in a desired position adjacent the drivers' door 18, 18′ of a stopped vehicle 15, 15′.

Turning to FIG. 4, remote inspection apparatus 20 can be mounted to a law enforcement vehicle 10, 10′ with a plurality of fasteners or mounts 28 that can be used to connect housing element 22 to a law enforcement vehicle 10, 10′. Fasteners 28 can be arranged to mount a remote inspection apparatus 20 to one or more light bars conventionally employed to mount emergency lights on law enforcement vehicles. Similarly, fasteners 28 can be mounted directly to the roof of a law enforcement vehicle 10,10′ if desired. Fasteners 28 can be adjustable to allow adjusting the elevation of a remote inspection apparatus in order to adjust the vertical position of surveillance end 30 when the remote inspection apparatus is extended as illustrated in FIG. 2. Fasteners 28 can be manually adjustable to allow the elevation of remote inspection apparatus 20 to be set in a fixed position, or can include an operator (not shown) to allow the elevation of the remote inspection apparatus to be adjusted in use by extending or shortening one or more of the fasteners 28 to adjust the elevation of surveillance end 30 to allow optimum inspection of the interior of stopped vehicle 15, 15′. Fasteners 28 can include a motor driven screw or hydraulic mechanism to controllably adjust the length of the fasteners 28 as is well known in the art.

Remote inspection apparatus 20 can be arranged to selectively inspect either side of a stopped vehicle as shown in FIGS. 2A and 2B. In order to inspect either side of a stopped vehicle remote inspection apparatus 20 can be pivotally or slidably mounted to the top of a law enforcement vehicle 10, 10′. Referring to FIG. 2A remote inspection apparatus 20 can be slidably mounted on light bars 27 on the roof of law enforcement vehicle 10, 10′ in a generally horizontal plane so that remote inspection apparatus can be positioned on either the left side or the right side of the vehicle 10, 10′. Travelers (not shown) on light bars 27 can move remote inspection apparatus 20 from side to side of vehicle 10 between the solid line and dashed line positions to allow inspection of either side of stopped vehicle 15. Referring to FIG. 2B remote inspection apparatus 20 can be pivotally mounted on law enforcement vehicle 10 about a generally vertical axis at a pivot 29 that can be provided on a light bar 27′ so that surveillance end 30 can swing to inspect either side of a stopped vehicle 15 between the solid line and dashed line positions. A traveler (not shown) on light bar 27″ can pivot remote inspection apparatus 20 about pivot 29. Those skilled in the art will understand that the travelers (not shown) can include electrical, hydraulic or mechanical drive mechanisms that are well known in the art.

Turning again to FIGS. 3 and 4, remote inspection apparatus 20 can include lights 32 and 34 at the opposite ends of the telescoping housing elements 22 and 26. Those skilled in the art will understand that lights 32 and 34 can be colored lights typically used on emergency vehicles such as red or blue, or can be clear or other colors as desired. Extendable boom 21 can include a surveillance end 30 can include one or more surveillance devices. Surveillance devices can include an imaging device 36 that can be a video camera, a night vision camera or a conventional photo camera or, if desired, two or more cameras to facilitate observation and inspection of the interior of a stopped vehicle in differing circumstances. Those skilled in the art will understand that imaging device 36 can be fixed or movably mounted in surveillance end 30 as desired to allow observation of the occupant(s) of a stopped vehicle 15, 15′. Imaging device 36 can also include a remotely controlled zoom lens to allow the operator in the law enforcement vehicle 10, 10′ to zoom in on an occupant of a stopped vehicle 15, 15′ to facilitate identification of the occupant. Use of a video camera and/or a night vision camera to observe the occupant(s) of a stopped vehicle are well known in the art. An advantage of including a night vision or infrared camera can be to allow surveillance of the occupant(s) of a stopped vehicle 15, 15′ having darkened windows. Imaging device(s) 36 can be connected to a controller 60 and display 62 positioned in the law enforcement vehicle as will be described in more detail below. Imaging device(s) 36 can be connected to controller 60 by suitable cables or can be connected by a wireless connection as is well known in the art.

Surveillance end 30 can include one or more lights 40 to illuminate the interior of a stopped vehicle 15, 15′. Light(s) 40 can be selected to illuminate the interior of a stopped vehicle 15, 15′ depending on the type(s) of camera to be used. For example if a night vision camera will be used light 40 can be selected to provide infrared light corresponding to the spectrum of the night vision camera. Similarly if a visible spectrum video camera is to be used light 40 can be a visible spectrum light source. Light(s) 40 can be connected to a controller 60 in the law enforcement vehicle for manual or automatic operation with imaging device(s) 36.

Surveillance end 30 can also include audio communication apparatus including a speaker and microphone 38 to allow verbal communication with the occupant(s) of a stopped vehicle 15, 15′. Speaker and microphone 38 can be connected to a controller 60 in the law enforcement vehicle 10, 10′ by a suitable cable or by a wireless connection as will be understood by those skilled in the art. When wireless connections are used surveillance end 30 can include a battery (not shown) for powering the surveillance devices.

Surveillance end 30 can also include a movable canister or document chamber 46 that can be movable carried in extendable boom 21. Surveillance end 30 can include a canister door 42 accessible by a stopped vehicle occupant(s) and housing element 22 can have a canister door 44 accessible by an occupant of law enforcement vehicle 10, 10′. Canister 46 can be used to transport a drivers' license or other identification document from the occupant(s) of a stopped vehicle 15, 15′ to law enforcement vehicle 10, 10′ for inspection and return to the stopped vehicle 15, 15′. Canister 46 can be movably carried by extendable boom 21 between surveillance end 30 and a location convenient for access from the law enforcement vehicle 10, 10′. Canister 46 can have a drive mechanism (not shown) to move canister 46 from surveillance end 30 to a location convenient for access from the law enforcement vehicle 10, 10′. Those skilled in the art will understand that a mechanical, electrical, pneumatic or hydraulic drive mechanism can be used for moving canister 46. Likewise, canister 46 can be movably carried inside or outside extendable boom 21.

Surveillance end 30 can also include a fingerprint collection surface or scanner and/or a detector (not shown) for controlled substances such as drugs and/or explosives in addition to, or in lieu of the surveillance devices described above. As with the other surveillance devices described above, a fingerprint scanner or detector for drugs, controlled substances and/or explosives can be connected to a controller 60 in the law enforcement vehicle 10, 10′ by wired or wireless connection as will be understood by those skilled in the art. Surveillance end 30 can be arranged to rotate about the longitudinal axis of remote inspection apparatus 20 to facilitate directing a video camera as a desired into a stopped vehicle 15, 15′. Likewise, surveillance end 30 can be articulated at the end of housing element 26 to allow 360° positioning of surveillance end 30 to allow maximum flexibility in operation of the remote inspection apparatus 20.

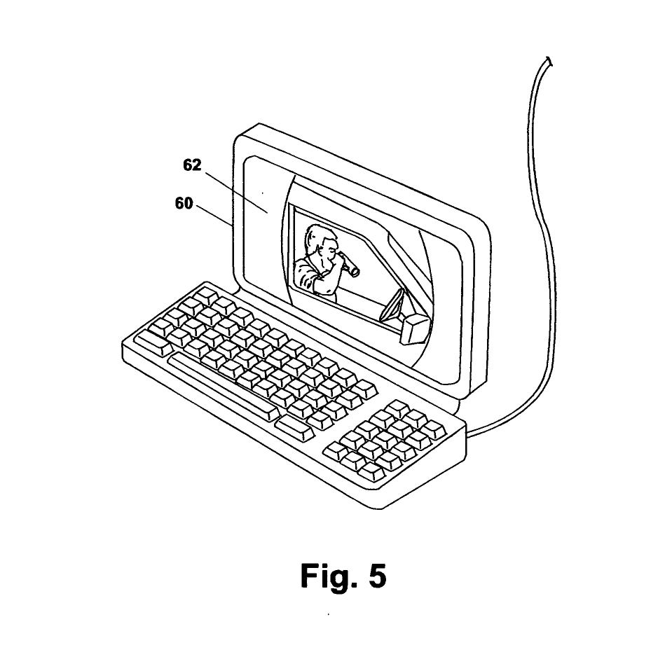

Turning to FIG. 5, remote inspection apparatus 20 can include a controller 60 that can be positioned for convenient access to law enforcement personnel in the law enforcement vehicle 10, 10′. Controller 60 can be arranged to control operation of remote inspection apparatus 20 including the drive arrangement to extend housing elements 24 and 26 and to operate the articulated surveillance end 30. When operable fasteners 28 are used to mount remote inspection apparatus 20 to a law enforcement vehicle 10, 10′ controller 60 can be arranged to control operation of the fasteners 28 to allow the operator to control the vertical and/or horizontal position of the surveillance end 30. Those skilled in the art will understand that vertical and/or horizontal adjustment of the remote inspection apparatus 20 can facilitate use of the apparatus with vehicles of differing sizes and for remotely inspecting the interior of vehicles smaller and larger than the law enforcement vehicle 10, 10′ on which the apparatus is mounted. Controller 60 can also be arranged to control the position of extendable boom 21 in embodiments (FIGS. 2A and 2B) where extendable boom 21 is pivotally or slidably mounted to a law enforcement vehicle 10, 10′.

Controller 60 can include a video display 62 to display images from imaging device 36 of the occupant(s) of stopped vehicle 15, 15′. Controller 60 can include a video camera (not shown) that can be connected to a video display (not shown) that can be positioned on surveillance end 30. Use of a video display on surveillance end 30 can allow visual communication between the law enforcement vehicle 10, 10′ and the occupant(s) of the stopped vehicle 15, 15′. Video display 62 can also include a microphone and speaker (not shown) that can be connected to the microphone and speaker 38 in surveillance end 30 for audio communication with the occupant(s) of the stopped vehicle 15, 15′. Thus, controller 60 and remote inspection apparatus 20 can provide audio and visual communication between a law enforcement vehicle and a stopped vehicle without exposing the law enforcement personnel to occupants of the stopped vehicle until the law enforcement personnel have had the opportunity to observe the occupants of the stopped vehicle. Video display 62 can also be arranged to display information generated by detectors for explosives and controlled substances as described above. Those skilled in the art will also understand that controller 60 can include controls, not shown, for operating remote inspection apparatus 20 to operate extendable boom 21 and position surveillance end 30 as desired to inspect a stopped vehicle 15, 15′, as well as operating and controlling the surveillance devices.

While the invention has been specifically described in connection with certain specific embodiments thereof, it is to be understood that this is by way of illustration and not of limitation, and the scope of the appended claims should be construed as broadly as the prior art will permit.

What is claimed is:

1. A remote inspection apparatus for inspecting a stopped vehicle from a second vehicle comprising:
a longitudinally extendable boom mounted to the second vehicle;
an imaging device positioned at the distal end of the boom;
a display device in the second vehicle connected to the imaging device; and
a controller for the extendable boom arranged to permit an operator positioned in the second vehicle to aim the imaging device into the stopped vehicle to allow the operator to inspect the interior of the stopped vehicle on the display device.

2. The remote inspection apparatus according to claim 1, wherein the extendable boom is extendable in a generally horizontal direction.

3. The remote inspection apparatus according to claim 1, wherein the extendable boom comprises an articulated distal end portion arranged to allow the operator to maneuver and control the field of view of the imaging device.

4. The remote inspection apparatus according to claim 1, wherein the extendable boom is vertically and horizontally movable to allow the operator to position the imaging device opposite a window of the stopped vehicle.

5. The remote inspection apparatus according to claim 1, wherein the extendable boom is pivotally mounted to the second vehicle about a generally vertical axis to allow the operator to position the imaging device on either side of the stopped vehicle to allow inspection of the stopped vehicle from either side.

6. The remote inspection apparatus according to claim 1, wherein the extendable boom is slidably mounted to the second vehicle in a generally horizontal plane to allow the operator to position the imaging device on either side of the stopped vehicle to allow inspection of the stopped vehicle from either side.

7. The remote inspection apparatus according to claim 1 further including audio communication apparatus positioned at the distal end and in the second vehicle arranged to permit the operator to communicate with an occupant in the stopped vehicle.

8. The remote inspection apparatus according to claim 1 further including a movable canister arranged for receiving a document from an occupant in the stopped vehicle, wherein the operator can collect a document from the stopped vehicle without leaving the second vehicle.

9. The remote inspection apparatus according to claim 1, further including a fingerprint collection surface on the distal end of the boom.

10. The remote inspection apparatus according to claim 1, further including a detector for detecting explosive materials.

11. The remote inspection apparatus according to claim 1, further including a detector for detecting controlled substances.

12. A remote inspection apparatus for inspecting a stopped vehicle from a second vehicle comprising:
a boom extendable in a generally horizontal direction mounted to the second vehicle having an articulated distal surveillance end;
a plurality of surveillance devices positioned in the surveillance end selected from a group including an imaging device and one or more lights, audio communication equipment including a microphone and speaker, a fingerprint scanner, an explosives detector, a controlled substance detector and a canister;
a controller for the extendable boom arranged to permit an operator positioned in the second vehicle operate the extendable boom, the articulated distal surveillance end portion and the plurality of surveillance devices to allow the operator to maneuver and control operation of the surveillance devices; and
a display device in the second vehicle connected to the controller to allow the operator to inspect the interior of the stopped vehicle on the display device and communicate with the occupant(s) of the stopped vehicle via the audio communication equipment.

13. The remote inspection apparatus according to claim 12, wherein the extendable boom is vertically and horizontally movable to allow the operator to position the imaging device opposite a window of the stopped vehicle.

14. The remote inspection apparatus according to claim 12, wherein the extendable boom is pivotally mounted to the second vehicle about a generally vertical axis to allow the operator to position the imaging device on either side of the stopped vehicle to allow inspection of the stopped vehicle from either side.

15. The remote inspection apparatus according to claim 12, wherein the extendable boom is slidably mounted to the second vehicle in a generally horizontal plane to allow the operator to position the imaging device on either side of the stopped vehicle to allow inspection of the stopped vehicle from either side.
